(19) United States
(12) Patent Application Publication
(10) Pub. No.: US 2018/0337431 A1
(43) Pub. Date: Nov. 22, 2018

(54) SYSTEMS AND METHODS FOR IMPROVING CELL BALANCING AND CELL FAILURE DETECTION

(71) Applicant: Maxwell Technologies, Inc., San Diego, CA (US)

(72) Inventor: Christopher James, San Diego, CA (US)

(21) Appl. No.: 15/984,264

(22) Filed: May 18, 2018

Related U.S. Application Data
(60) Provisional application No. 62/509,555, filed on May 22, 2017.

(51) Int. Cl. H01M 10/42; H01M 10/48; H01G 9/00

(52) U.S. Cl. CPC H01M 10/425; H01M 10/482; H01M 2010/4278; H01M 2010/4271; H01G 9/0003

(57) ABSTRACT

One innovative aspect of the subject matter described herein comprises an energy storage module that comprises one or more energy storage cells, one or more sensor circuits, a network interface, and a first safety circuit. The sensor circuits detect a condition of the energy storage module indicative of a malfunction. The first safety circuit monitors the sensor circuits for detection of the condition indicative of a malfunction. The first safety circuit receives a pulsed signal. When the one or more sensor circuits detect the condition indicative of a malfunction, the first safety circuit interrupts the pulsed signal being conveyed. When the one or more sensor circuits does not detect the condition indicative of a malfunction, the first safety circuit conveys the pulsed signal. A unique network identifier of the network interface is determined based on an arbitration method using said network interface in conjunction with the first safety circuit.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure relates generally to energy storage devices, and in particular, energy storage devices deployed in modules, each module containing some number of energy storage cells.

### Description of the Related Art

Various systems and techniques exist for communicating signals between energy storage modules and cells. These signals may include interrupt signals, communication signals, or any other signals relating to operation of the energy storage modules or a system of energy storage modules. For example, the energy storage modules may communicate or share a circuit that may trigger a safety shutdown in a system malfunction event. Previously, such signals may have been manually communicated or communicated by individual means. For example, each module may have been individually or independently coupled to a controller that controlled the shutdown of each module individually and/or independently. Thus, prior approaches do not fully and efficiently communicate interlock signals between energy storage modules or the system of energy storage modules with a confidence of hardware interlocks. Such confidences may decrease further as a quantity of energy storage modules in the system increases.

Additionally, when the system of energy storage module comprises multiple energy storage modules, each of the energy storage modules forming the system may be coupled to a communication network. On this communication network, each of the energy storage modules may have a unique identifier. In some prior approaches, the network identifier of each of the energy storage modules was individually set by a user. Thus, prior approaches do not efficiently establish communications or network conditions for all energy storage modules or the system of energy storage modules.

### SUMMARY

Embodiments disclosed herein address the above-mentioned problems with prior art. The systems, methods and devices of this disclosure each have several innovative aspects, no single one of which is solely responsible for the desirable attributes disclosed herein.

Although the examples provided in this disclosure are sometimes described in terms of capacitors or capacitor cells, such as ultracapacitors or ultracapacitor cells, or batteries or battery cells, the concepts provided herein may apply to other types of energy storage systems.

One innovative aspect of the subject matter described herein comprises an energy storage module. The energy storage module comprises one or more energy storage cells, one or more sensor circuits, a network interface, and a first safety circuit. The one or more sensor circuits are configured to detect a condition of the energy storage module indicative of a malfunction of the energy storage module. The first safety circuit is configured to monitor the one or more sensor circuits for detection of the condition indicative of a malfunction of the energy storage module. The first safety circuit is further configured to receive a pulsed signal. When the one or more sensor circuits detect the condition indicative of a malfunction of the energy storage module, the first safety circuit is configured to interrupt the pulsed signal being conveyed from the first safety circuit. When the one or more sensor circuits does not detect the condition indicative of a malfunction of the energy storage module, the first safety circuit is configured to convey the pulsed signal from the first safety circuit. A unique network identifier of the network interface is determined based on an arbitration method using said network interface in conjunction with the first safety circuit.

One innovative aspect of the subject matter described herein comprises a method of monitoring an energy storage module. The method comprises detecting a condition of an energy storage module indicative of a malfunction of the energy storage module. The method further comprises receiving a pulsed signal and determining an unique network identifier of a network interface based an arbitration method using said network interface in conjunction with a safety circuit. The method also comprises interrupting the pulsed signal being conveyed from a first safety circuit when the condition indicative of a malfunction of the energy storage module is detected and conveying the pulsed signal from the first safety circuit when the condition indicative of a malfunction of the energy storage module is not detected.

One innovative aspect of the subject matter described herein comprises an energy storage module, comprising means for detecting a condition indicative of a malfunction of the energy storage module. The module further comprises means for monitoring the means for detecting for detection of the condition indicative of a malfunction of the energy storage module and means for receiving and conveying a pulsed signal. The module also comprises means for determining an unique network identifier of a network interface based an arbitration method using said network interface in conjunction with the means for receiving and conveying. The module also further comprises means for interrupting the pulsed signal being conveyed from the means for receiving and conveying when the condition indicative of a malfunction of the energy storage module is detected. The means for receiving and conveying a pulsed signal conveys the pulsed signal when the condition indicative of a malfunction of the energy storage module is not detected.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims.

FIG. 1A illustrates an energy storage system comprising a plurality of energy storage modules and a system controller, in which aspects of the present disclosure can be employed.

FIG. 1B illustrates an energy storage system comprising a plurality of energy storage modules and a plurality of system controllers, in which aspects of the present disclosure can be employed.

FIG. 2 illustrates various components that may be utilized in the energy storage modules that may be employed within the energy storage system of FIG. 1A.

FIG. 3 illustrates an example of a distributed safety circuit that forms a high voltage interlock loop (HVIL) in an exemplary embodiment of the present disclosure.

FIG. 4 illustrates a method of including an interlock loop for use with a method for automatically configuring communication identifiers in the energy storage modules.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numbers and designations in the various drawings indicate like elements.

### DETAILED DESCRIPTION

The detailed description set forth below in connection with the appended drawings is intended as a description of exemplary implementations and is not intended to represent the only implementations in which the invention may be practiced. The term “exemplary” used throughout this description means “serving as an example, instance, or illustration,” and should not necessarily be construed as preferred or advantageous over other exemplary implementations. Any implementation described herein as “exemplary” is not necessarily to be construed as preferred or advantageous over other implementations. The detailed description includes specified details for the purpose of providing a thorough understanding of the exemplary implementations. In some instances, some devices are shown in block diagram form.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different communication technologies, system configurations, safety protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The following description is presented to enable any person skilled in the art to make and use the embodiments described herein. Details are set forth in the following description for purpose of explanation. It should be appreciated that one of ordinary skill in the art would realize that the embodiments may be practiced without the use of these specific details. In other instances, well known structures and processes are not elaborated in order not to obscure the description of the disclosed embodiments with unnecessary details. Thus, the present application is not intended to be limited by the implementations shown, but is to be accorded with the widest scope consistent with the principles and features disclosed herein.

Energy storage systems can include one or more, and in some embodiments, a plurality of energy storage cells, such as individual battery, capacitor, or ultracapacitor cells. A plurality of such cells can be arranged in series to form an energy storage module or bank which has a higher voltage output than an individual cell. The modules in turn can be connected in series with other modules to output higher combined voltages. The individual capacitors or batteries of a module are sometimes referred to as capacitor cells or battery cells, respectively, or more generally, cells. In some embodiments, the energy storage modules may form an energy storage system. The energy storage system may include an independent controller, such as a supervisory controller, to provide various control functionality.

Various conditions can cause issues with the system of energy storage modules. Given the potentially dangerous power levels that may be contained within the system (for example, multi-megawatt energy storage systems with voltages in the tens of kV), the system may include one or more safety shut down circuits that reduce potential for exposure to dangerous power levels in certain conditions. In some embodiments, the safety shut down circuits may comprise a single distributed circuit, wherein the circuit is distributed among the energy storage modules of the system. For example, the safety shut down circuit may be configured to disconnect one or more of the energy storage modules forming a system string voltage from other energy storage modules. In some implementations, the safety shut down circuit may include a high voltage interlock loop (HVIL). In some implementations, the HVIL may comprise an analog or digital circuit that serially connects each energy storage module of the system. The HVIL may provide a path for a voltage or current signal to pass between the energy storage modules. In some implementations, the voltage signal may comprise a pulse or a pulse train, an arbitrary pulse train, and/or a variation of a voltage on the voltage signal. For example, the pulse may comprise a periodic pulse that occurs at timed intervals, or a constant signal that does not vary with time. In some implementations, the periodic pulse may be a pulse used to communicate information between one or more of the energy storage modules of the system. In some implementations, the voltage signal may comprise a low voltage, for example 5 volt (V), signal. In some implementations, the voltage signal may comprise a 1V, 12V, or 24V signal or a signal of any voltage less than or equal to 120V.

In some implementations, each of the energy storage modules may comprise a controller and/or some other monitoring circuit(s). In some implementations, the controller and/or circuits may monitor the corresponding energy storage module to detect conditions of the energy storage module indicative of a malfunction of the energy storage module. For example, the controller and/or circuits may monitor the corresponding energy storage module for problematic voltage or temperature conditions, such as overvoltage conditions or over temperature conditions, or other potentially damaging conditions. Additionally, or alternatively, the controller and/or circuits may monitor for communications from the controller for the particular energy storage module to ensure that active communications are being maintained. In a situation where any one or more of the potentially damaging conditions, such as overvoltage, over temperature, or lack of communication/operation from the controller is detected in one of the energy storage modules, the distributed safety shutdown circuit may be activated to indicate an issue and to disrupt the potentially dangerous condition, such as high voltage flow or throughput, in the system.

Additionally, in some implementations, the system may include a large number of energy storage modules that may be distributed in various locations. Accordingly, the energy storage modules may be networked to communicate with each other, for example, via a controller area network (CAN) bus or similar communications protocol. However, initially providing unique network identifiers to each of the energy storage modules in a sequenced manner corresponding to a position of the energy storage modules in the series of the system may be problematic. Providing such sequenced and understandable network identifiers may include or utilize individually programming or setting the energy storage module network identifiers, which may involve individually accessing each energy storage module. This may be a tedious and time consuming task, for example, in a system with a large number of energy storage modules.

To avoid having to individually program or set the energy storage module identifiers, in some implementations, the same HVIL signal may assist in automatically providing and/or determining network identifiers for each of the coupled energy storage modules. When each energy storage module of the system is coupled in series, each energy storage module may be assigned a unique network identifier in a sequential (or other) manner. Accordingly, when the HVIL is provided by a single wire or communication path between the energy storage modules of the system, the HVIL signal may serve its function as the interlock and also assist with the assignment of network identifiers to all of the energy storage modules of the system.

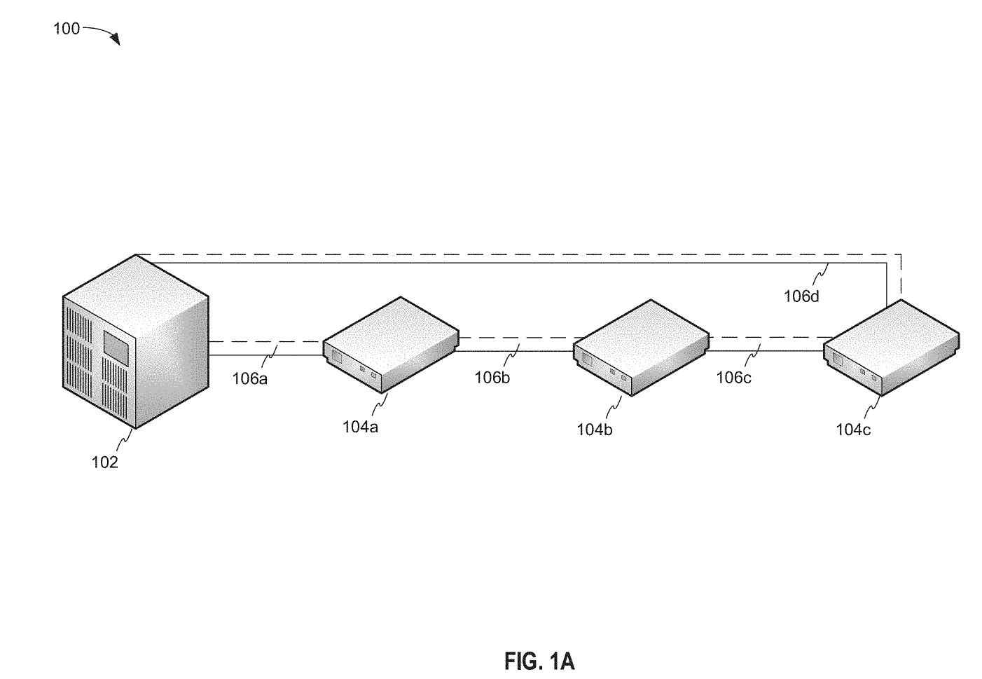

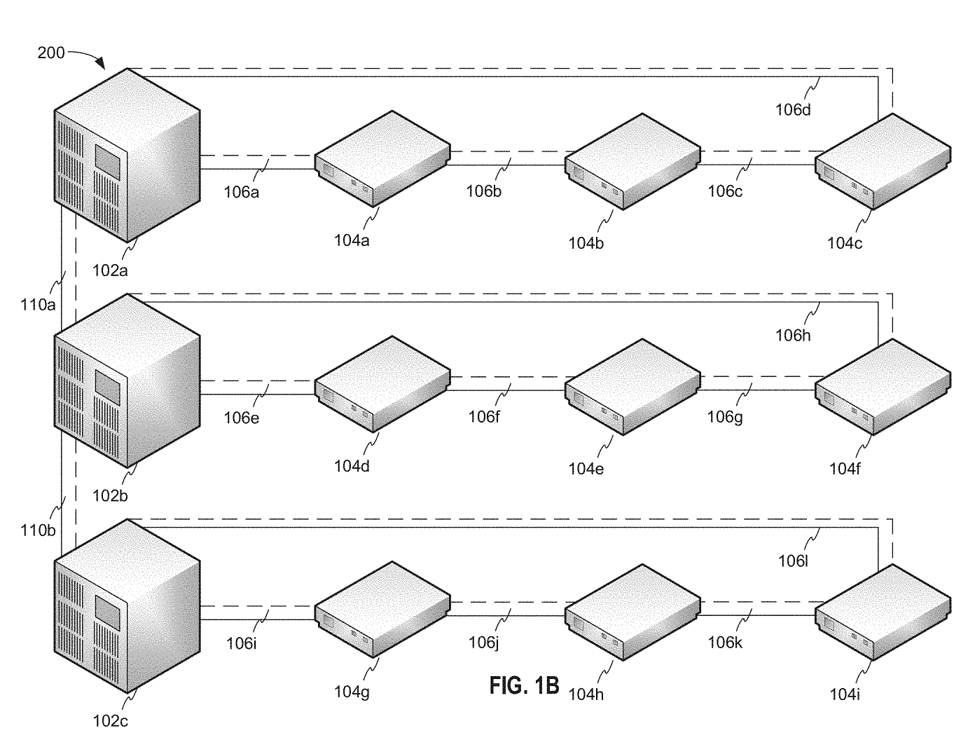

FIG. 1A illustrates an energy storage system 100 comprising a plurality of energy storage modules 104a-104c and a system controller 102, in which aspects of the present disclosure can be employed. The system 100 as shown includes the system controller 102 and three energy storage modules 104a-104c. Components of the system 100 may be coupled via links 106. The links 106 may comprise communication links to allow the components to communicate with each other or to pass information or signals between each other. In some implementations, the links 106 may also comprise interlock signals between each of the energy storage modules 104a-104c. Thus, in some implementations, the links 106 may comprise one or both of communication links and interlock links. Though not shown in this figure, in some implementations, a link (for example, communication link and/or interlock link) may exist between the system controller 102 and the energy storage module 104c.

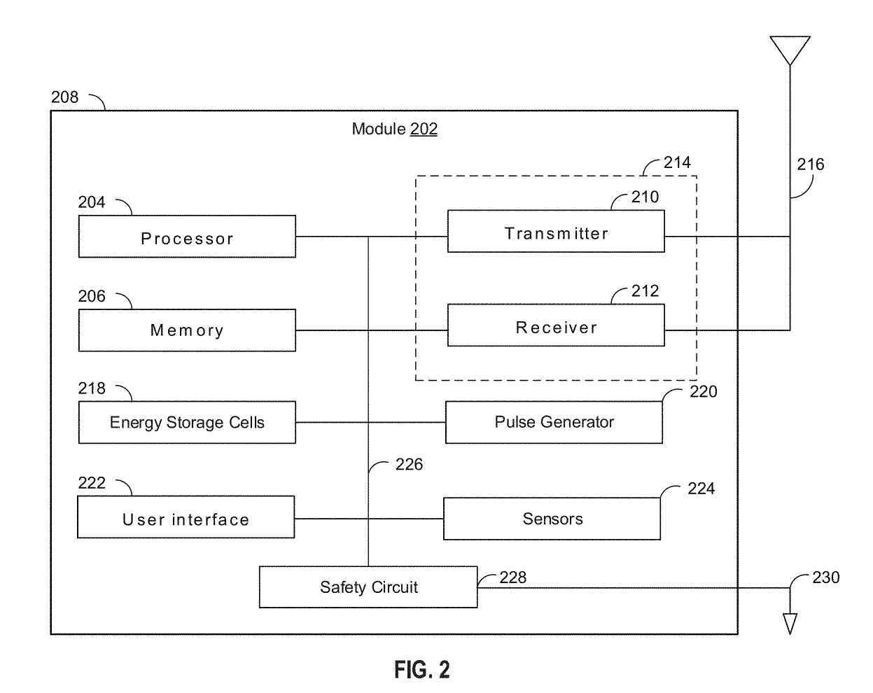

In some implementations, the system 100 may include any number of energy storage modules 104. In some implementations, the functionality described herein with respect to the system controller 102 can be implemented in a controller separate from the energy storage modules 104a-104c, as shown, or the functionality described herein for the system controller 102 can be implemented as part of one or more of the energy storage modules in the system 100, as described further below with respect to module 202 in FIG. 2. Though not explicitly shown, the components of the system 100 may communicate via one or more communication protocols and/or means, for example, via the communication links of the links 106. In some implementations, the components of the system 100 may communicate wirelessly (for example, via an IEEE 802.11, an LTE, or other wireless communication protocol). In some implementations, the components of the system 100 may communicate over a wired network (for example, via Ethernet, CAN bus, Field bus, or any other wired communication protocol). In some implementations, the components of the system 100 may communicate an interlock signal via the interlock links of the links 106.

In some implementations, the controller 102 and the energy storage modules 104a-104c may be coupled in series as shown over the communication network. In some implementations, the communication network coupling the controller 102 and the energy storage modules 104a-104c may be coupled in some other configuration (for example, a “ring”), where each energy storage module 104a-104c is coupled directly to two other energy storage modules 104, or a “star,” where each energy storage module 104a-104c is independently coupled to the controller 102. The controller 102 and/or the energy storage modules 104a-104c may communicate various information between each other. In some implementations, one of the energy storage modules 104a-104c may be designated as a “master” of the energy storage modules 104a-104c in the system 100. An example master energy storage module 104a may communicate information from individual energy storage modules 104a-104c of the system 100 or aggregate information from one or more of the energy storage modules 104a-104c for communication, for example, to an upstream controller. For example, the master energy storage module 104a may communicate voltages, currents, etc. of one of the energy storage modules 104a-104c or a combined voltage, etc., of two or more of the energy storage modules 104a-104c.

In addition to the communication links of the links 106, the controller 102 and the energy storage modules 104a-104c may be coupled in series via a high voltage interlock loop (HVIL) in a linear, ring daisy-chained, or two-dimensional array manner. Via the HVIL, the controller 102 and the energy storage modules 104a-104c may communicate or convey a safety interlock. Accordingly, the controller 102 (or the first energy storage module 104a) may include a pulse generator. This pulse generator may produce a pulse signal that is communicated between each energy storage module 104a-104c of the system 100. In some implementations, the pulse signal may comprise a pulse train, an arbitrary pulse train, and/or a variation of a voltage on the voltage signal. For example, the pulse may comprise a periodic pulse that occurs at timed intervals, or a constant signal that does not vary with time. In some implementations, the voltage signal may comprise a low voltage, for example 5 volt (V), signal. Each of the energy storage modules 104a-104c may include circuitry that monitors and further communicates or conveys the pulse signal over the HVIL. Thus, the communication links 106 may comprise one or both of links for the communication network and the HVIL.

FIG. 1B illustrates an energy storage system 200 comprising a plurality of energy storage modules 104a-104i and a plurality of system controllers 102a-102c, in which aspects of the present disclosure can be employed. The system 200 as shown includes the system controller 102a coupled to the three energy storage modules 104a-104c via links 106a-106d. The links 106a-106d may correspond to the links 106 a described in relation to FIG. 1A. The system 200 as shown also includes the system controller 102b coupled to the three energy storage modules 104d-104f via links 106e-106h. The links 106e-106h may correspond to the links 106 a described in relation to FIG. 1A. The system 200 as shown includes the system controller 102c coupled to the three energy storage modules 104g-104i via links 106i-106l. The links 106i-106l may correspond to the links 106a described in relation to FIG. 1A.

In some implementations, the system 200 may include any number of energy storage modules 104 and/or any number of system controllers 102. In some implementations, the system controllers 102 may be coupled together via one or more of links 110. In some implementations, the links 110 may correspond to the links 106 described in relation to FIG. 1A. The combination of the linked system controllers 102, each system controller 102 individually linked to a chain of energy storage modules 104, may form an array of energy storage modules 104. Each of the system controllers 102 may monitor the HVIL of each of their respective chains of energy storage modules 104 and convey a status of its chain's HVIL via the links 110 to the other system controllers 102. In some implementations, the system controllers 102 may be coupled to a master controller (not shown) that monitors the HVIL of the system controllers 102. The master controller may determine, when one or more of the system controllers 102 indicates that its chain's HVIL is not complete, whether or not the two-dimensional array of energy storage modules 104 may maintain operations or should be shut down. In some implementations, the functionality described herein with respect to the master controller can be implemented in a controller separate from the system controllers 102 or the functionality described herein for the master controller can be implemented as part of one or more of the system controllers 102 in the system 200.

In some implementations, the system controllers 102a-102c may be coupled in series as shown over the communication network. In some implementations, the communication network coupling the system controllers 102 may be coupled in some other configuration (for example, a “ring,” where each system controller 102 is coupled directly to two other system modules 102, or a “star,” where each system controller 102 is independently coupled to the master controller. The system controllers 102 may communicate various information between each other, including status of their respective energy storage modules and/or their individual HVIL. In some implementations, the master controller may communicate information from individual energy storage modules 104a-104i or individual system controllers 102a-102c and chains of the system 200 or aggregate information from one or more of the energy storage modules 104a-104i or system controllers 102a-102c for communication, for example, to the upstream controller. For example, the master controller may communicate voltages, currents, etc. of one of the energy storage modules 104a-104i or a combined voltage, etc., of two or more of the energy storage modules 104a-104i.

FIG. 2 illustrates various components that may be utilized in the controller 102 or the energy storage modules 104a-104c that may be employed within the energy storage system 100 of FIG. 1A or 200 of FIG. 1B. The module 202 is an example of a device that can be configured to implement the various methods described herein. With respect to the description of FIG. 2 herein, some of the item numbers may refer to the so-numbered aspects described above in connection with FIG. 1A. For example, the module 202 may comprise components of one of the energy storage modules 104a-104c and/or the controller 102. In some implementations, the controller 102 and/or the energy storage modules 104a-104c may not include each of the components shown in the module 202. In some implementations, the controller 102 and/or the energy storage modules 104a-104c may include additional components not shown in the module 202.

The module 202 may include a processor 204 which controls operation of the module 202. The processor 204 may also be referred to as a central processing unit (CPU) or hardware processor. Memory 206, which may include both read-only memory (ROM) and random access memory (RAM), may provide instructions and/or data to the processor 204 and may serve as a repository for storage of instructions and/or data from the processor 204. A portion of the memory 206 may also include non-volatile random access memory (NVRAM). The processor 204 typically performs logical and arithmetic operations based on program instructions stored within the memory 206 or instructions and/or data received. The instructions in the memory 206 may be executable to implement the methods described herein. Furthermore, the module 202 may utilize the memory 206 to store information about other components in the system 100 to enable the use of certain methods described below, for example, storing identifiers for particular components and/or characteristics for components on the network. The module 202 may then utilize the processor 204 in connection with the memory 206 to analyze the stored data and determine and/or identify various sets, categories, characteristics, or otherwise, for one or more of the other components in the system 100.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include non-transitory machine-readable media for storing software. Software shall be construed broadly to mean any type of instructions, whether referred to as software, firmware, middleware, microcode, hardware description language, or otherwise. Instructions may include code (for example, in source code format, binary code format, executable code format, or any other suitable format of code). The instructions, when executed by the one or more processors, cause the processing system to perform the various functions described herein. The processor 204 may further comprise a packet generator to generate packets for controlling operation and data communication.

The module 202 may include a networking components, for example, a transmitter 210 and a receiver 212 to allow transmission and reception of data between the module 202 and a remote location. The transmitter 210 and the receiver 212 may be combined into a transceiver or network interface 214. The network interface 214 (and/or the transmitter 210 and the receiver 212) may be coupled to the remote location via communication link 216, which may comprise a wireless or wired communication link. In some implementations, the communication link 216 may comprise a link to the CAN bus network described herein. The module 202 may also include (not shown) multiple transmitters, multiple receivers, multiple transceivers, and/or multiple communication links, which may be utilized during multiple-input multiple-output (MIMO) communications, for example. In some embodiments, multiple communication links 216 may be dedicated for the transmission and/or reception of particular protocols. In some implementations, the network interface may be configured to operate with the processor 204 to communicate over the communication link. In some implementations, the processor 204 may work with the network interface to determine or identify a network identifier.

The module 202 may be covered by a housing unit 208.

The module 202 may also include a plurality of energy storage cells 218. The energy storage cells 218, as described herein, may comprise a plurality of individual battery or ultracapacitor cells arranged in series. In some implementations, the module 202 may include one or more circuits or sensors 224 configured to monitor an operation or a condition of the energy storage cells 218. The sensors 224 can be configured to detect conditions of the energy storage module indicative of a malfunction of the energy storage module. For example, the sensors 224 may be configured to detect one or more of an overvoltage condition or an over temperature condition of the module 202. In some implementations, the sensors 224 may be configured to monitor operation of the processor 204. Should the sensors 224 detect the overvoltage or over temperature condition or determine that the processor 204 is non-responsive, and then the sensors 224 may generate an output. In some implementations, the output from the sensors 224 may be communicated via the transmitter 210 or the network interface 214 over the communication link 216. In some implementations, the output from the sensors 224 may be communicated internally to another component of the module 202, for example the processor 204.

The module 202 may also include a pulse generator 220. The pulse generator 220 may be configured to generate a pulse signal to be communicated via the HVIL, as described herein. In some implementations, the pulse may comprise a pulse having a voltage in the range of 1V to 24V or up to 120V. In some implementations, the pulse may be used to communicate information via modulation, and so forth. In some implementations, the pulse may be the periodic pulse or a constant amplitude and frequency signal.

In some implementations, the pulse may have a voltage greater than 24V. In some implementations, the pulse may have a length or period that may be adjusted based on application requirements. The module 202 may include pulse generator 220, for example, when the module 202 provides the functionality described herein for the controller 102 (FIG. 1A). In some implementations, the pulse generator 220 may be provided in one of the energy storage modules 104a-104c in the system 100. For example, the pulse generator 220 may be provided in the module 202 when the module 202 represents the first energy storage module in a series of energy storage modules in the system 100. In some implementations, each module 202 (for example, each of the controller 102 and the energy storage modules 104a-104c) includes the pulse generator 220 so that each module 202 is able to reproduce pulses for communication to one or more other modules 202 in the system 100. In some aspects, the pulse generator 220 may be operationally connected to the processor 204 and may share resources with the processor 204.

The module 202 may further comprise a user interface 222 in some aspects. The user interface 222 may comprise a keypad and/or a display. The user interface 222 may include any element or component that conveys information to a user of the wireless device 202 and/or receives input from the user.

The module 202 may further comprise a safety circuit component 228. In some implementations, the safety circuit 228 may comprise a component in a distributed circuit (for example, the HVIL) of the system 100 or the system 200. In some implementations, the safety circuit 228 comprises a component that may be toggled or triggered (for example, by the processor 204 or in response to the output from the sensors 224) to react to a detected condition, for example a malfunction condition. For example, when toggled or controlled by the output of the sensors 224, the safety circuit 228 may be toggled when the sensors 224 detect an overvoltage or over temperature condition or determines that the processor 204 is nonresponsive (for example, a processor watchdog fault). In some implementations, the safety circuit 228 may include an input and an output (not shown). The safety circuit 228 may be configured to receive a pulsed signal (for example, via the input) and convey the pulsed signal (via the output) via the HVIL and link 230 if the safety circuit does not sense detect any malfunction condition. In some implementations, the safety circuit 228 may be coupled to the HVIL indicated by link 230, which may couple the safety circuits 228 of all connected modules 202. For example, the input of the safety circuit 228 may be coupled to an output of a safety circuit 228 of the previous (i.e. upstream) module 202 or the pulse generator 220 (when the pulse generator is either upstream of the module 202 or contained within the module 202). In some implementations, the output of the safety circuit 228 may be coupled to an input of a safety circuit 228 of a subsequent (i.e. downstream) module 202.

In some implementations, when the module 202 is initialized, the safety circuit 228 may be open. Accordingly, the module 202 may perform an initial check of the circuits or sensors 224 and/or the processor 204 to determine if any malfunction exists. If no malfunction is detected in the module 202, then the safety circuit 228 may be closed. Accordingly, no module 202 may convey the pulse signal unless no malfunction exists that is tied in to the safety circuit 228.

In some implementations, the safety circuit 228 may be further configured to receive the pulse signal via the link 230. Based on the conditions detected using the sensors 224 or a command from the processor 204, the safety circuit 220 may allow or interrupt the communication or conveyance of the pulse signal to other modules of the system 100. In some implementations, interrupting the communication or conveyance of the pulse signal may comprise modulating or adjusting the pulse signal. For example, the safety circuit 220 may truncate the pulse signal, thereby truncating a message being communicated via the pulse signal. In some implementations, the safety circuit 220 may change a parameter of the pulse signal, such a pulse width, amplitude, frequency, etc. In some embodiments, the modified or truncated pulse signal may be used to communicate various information, including the identified problem with the energy storage module 202. For example, the modified or truncated pulse signal may identify an overvoltage or similar problem. In some implementations, the module 202 may generate a pulse signal via the pulse generator 220 to convey to a downstream module 202 in the HVIL when the pulse signal is received from the upstream module 202 and when no malfunctions are detected within the module 202. In some implementations, the safety circuit 228 may communicate aspects of the received pulsed signal to the processor 204. For example, the receive pulsed signal may be used by the processor 204 to determine and/or establish a network identifier for the network interface 214 and associated components.

In some implementations, the network interface 214, the processor 204, the network interface 214, and the safety circuit 228 may assist in determining and/or establishing the network identifier for the network interface 214. For example, in the implementation where the network interface 214 communicates via the CAN bus protocol, when the system is initialized (or reset, etc.), the network interfaces 214 of all modules 202 of the system 100 may communicate using either a previously assigned network identifier or with a default network identifier. After initialization, the network interfaces 214 each communicate with each other to automatically generate network identifiers (for example, addresses) for each of the network interfaces 214. In some implementations, this automatic addressing may be used in conjunction with the pulse signal received via the safety circuit 228 of each module 202. Since the modules 202 are configured in a sequential manner (for example, in the linear or ring configuration), the order in which the modules 202 receive the pulse signal corresponds to the position of each module in the configuration. For example, the first module 202 in the configuration will also receive the pulse signal first (or may generate the pulse signal).

Thus, when the network interfaces 214 are in an automatic addressing mode, the pulse signal may be used to indicate where each module 202 is positioned in the network configuration. For example, the first module 202 may receive the pulse signal from the pulse generator (or generate the pulse signal via the pulse generator 220). The first module 202 may identify itself, using the network interface 214, on the communication network as being the first node or module in the communication network. For example, the first module 202 may have or reserve a network identifier of “1”. The first module 202 may also close its safety circuit. Accordingly, the first module 202 may convey the pulse signal to a second module 202 in series. Once the second module 202 in series receives the pulse signal, the second module 202 may use the network interface 214 to identify itself as being the second, or subsequent, node or module in the communication network. For example, the first module 202 may have or reserve a network identifier of “2,” which is the next available network identifier. The second module 202 may also close its safety circuit and convey the pulse signal to a third module 202 in series. These steps may be repeated until all modules 202 in the system 100 are assigned network identifiers or addresses. Accordingly, a module 202 that receives the pulse signal via the safety circuit may reserve the next available network identifier since the safety circuits will receive the pulse single in a sequential order, which is correlated with the network identifiers or addresses.

Various components of the module 202 may be coupled together by a bus system 226. The bus system 226 may include a data bus, for example, as well as a power bus, a control signal bus, and a status signal bus in addition to the data bus. Those of skill in the art will appreciate various components of the module 202 may be coupled together or accept or provide inputs to each other using some other mechanism. In some implementations, though not shown, the module 202 may include a high voltage connection between itself and the series of modules 202. For example, when the module 202 represents one or more of the energy storage module(s) 104a-104c (FIG. 1A), the module 202 may include high voltage connections or couplings and high voltage circuits to manage the high voltages. In some implementations, the high voltage connections or couplings may be directly integrated with the energy storage cells 218, which may include some low voltage components (not shown) coupled to the bus 226. In some implementations, the bus system 226 may include an interlock system that couples the pulse generator 220 to the safety circuit 228.

Although a number of separate components are illustrated in FIG. 2, those of skill in the art will recognize that one or more of these components may be implemented not only with respect to the functionality described above, but also to implement the functionality described above with respect to other components. For example, the processor 204 may be used to implement not only the functionality described above with respect to the processor 204, but also to implement the functionality described above with respect to the pulse generator 220 and/or the sensors 224. Each of the components illustrated in FIG. 2 may be implemented using a plurality of separate elements.

As noted above, the module 202 may comprise the controller 102 or one of the energy storage modules 104a-104c (FIG. 1A). In some implementations, a portion of the communication link 216 that facilitates communication to a module 202 can be referred to as a downlink (i.e., the portion of the communication link 216 that points to the module 202), and a portion of the communication link 216 that facilitates communication from a module 202 can be referred to as an uplink (i.e., the portion of the communication link 110 that points from the module 202). Alternatively, a downlink can be referred to as a forward link or a forward channel, and an uplink can be referred to as a reverse link or a reverse channel.

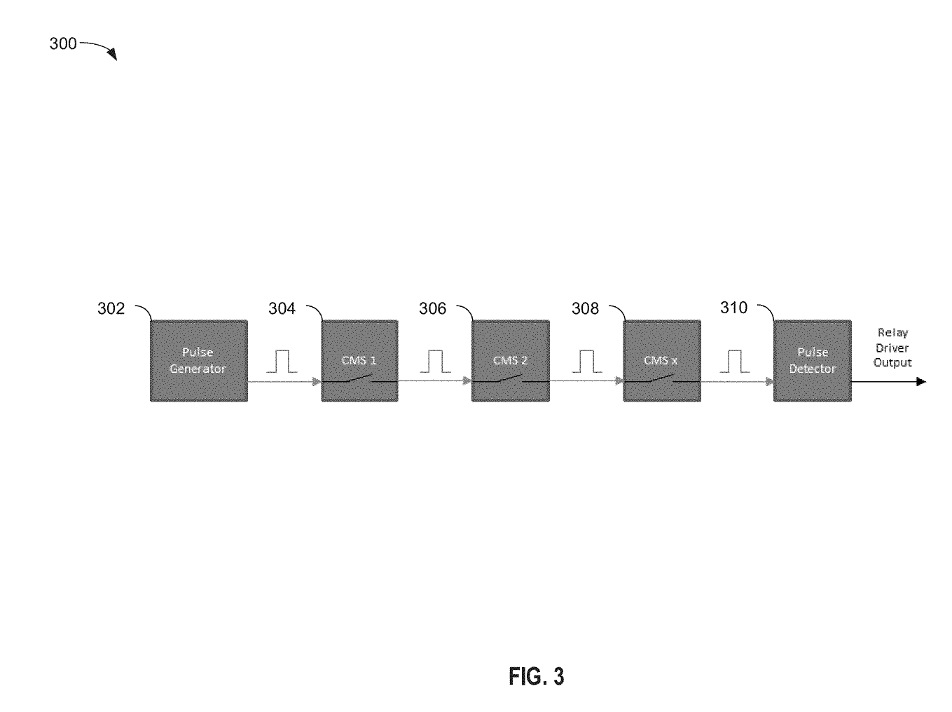

FIG. 3 illustrates an example of a distributed safety circuit 300 that forms the HVIL and may be implemented to provide functionality between a series of energy storage modules 304-308, a pulse generator 302, and a pulse detector 310. The circuit 300 and its components can be similarly implemented with and provide similar functionality to the energy storage modules 104a-104c and the system controller 102 of the system 100 in FIG. 1A. For example, one or more of the components of the distributed safety circuit 300 may be distributed between the components of the system 100. For example, the pulse generator 302 (which can correspond to the pulse generator 220 of FIG. 2) may be located in the controller 102 of the system 100 or in one or more of the energy storage modules 104a-104c, such as a first energy storage module, of the system 100. In some implementations, the modules 304-308 may correspond to the energy storage modules 104a-104c of the system 100. In some implementations, the module 308 leads to a pulse detector 310. The path from the pulse generator 302 through the modules 304-308 and to the pulse detector 310 may comprise the HVIL described herein. In some implementations, the pulse detector 310 may correspond to a component within one of the modules 104a-104c.

As shown, the distributed safety circuit 300 may begin with the pulse generator 302. The pulse generator may be configured to generate a pulse that is communicated or conveyed to the first module 304 connected in series with the pulse generator 302. The first module 304 may include a safety circuit component or set of components that monitors the first module 304. If the first module 304 is in proper operating order (for example, no alarms exist and the processor for the first module 304 appears to be operating correctly), then the first module 304 may continue to pass the pulse signal through to the second module 306. Alternatively, or additionally, if the first module 304 is not in proper operating order (for example, a malfunction or an alarm exists and/or the processor for the first module 304 is not operating properly), then the first module 304 may not pass the pulse signal through to the second module 306. Some alarms may not break the HVIL loop. For example, in some implementations, only alarms indicating a malfunction in the safety, functionality, or operation of the first module 304 may break the HVIL loop. Accordingly, the safety circuit of the first module 304 may act as an open or closed switch for the pulse signal based on the condition of the first module 304. The first module 304 safety circuit component is an open switch when the first module 304 is experiencing an issue or not operating properly and a closed switch when the first module is not experiencing any issues and is operating properly. Each of the subsequent modules 306 and 308 may operate in a similar manner where they allow the pulse signal to pass through when conditions are proper and do not pass the pulse signal when the conditions are not proper.

At the end of the safety circuit 300 is a pulse detector 310. The pulse detector 310 may be configured to receive the pulse signal from the module 308 and indicates the receipt of the pulse signal to a controller or other device, for example, the controller 102 (FIG. 1A). In some implementations, the pulse detector 310 may be located in the last module of the system 300. In some implementations, the pulse detector 310 may be located in the controller 102. In some implementations, the pulse detector 310 may be a stand alone unit that communicates to the controller 102 whether or not the pulse made it through each of the modules 304-308 and to the pulse detector 310. When operating conditions are proper for all of the modules 304-308, then the pulse signal may pass through each of the modules 304-308 to the pulse detector 310. Thus, when the pulse makes it through to the pulse detector 310, all of the modules 304-308 are operating properly. When the pulse does not make it through to the pulse detector 310 (for example, when pulse is interrupted), at least one of the module 304-308 are not operating properly. In some embodiments, when one of the safety circuits 228 of the modules 304-308 identifies an issue and interrupts the pulse, the remainder of the pulse (for example, when the safety circuit 228 only truncates or modifies the pulse signal) may be used to identify an issue with the at least one module 304-308 that is not operating properly.

Furthermore, in addition to providing the signal path for the high voltage pulse, which is utilized to trigger a redundant safety shutdown in the event of a malfunction of one of the energy storage modules 304, 306, and/or 308, the HVIL may also be used to sequence the energy storage modules 304, 306, and/or 308 as described herein. Such sequencing may ensure that unique network identifiers may be automatically assigned to each of the energy storage modules 304, 306, and/or 308 in series. As noted herein, in previous systems 300 comprising a large number of energy storage modules 304, 306, and/or 308, each energy storage module had a unique network identifier that may have been set by a user, which required a large amount of time and effort.

In such an implementation, the HVIL may be used to determine the unique network identifiers to the individual modules 304, 306, and/or 308 to allow the modules to automatically set their network interfaces (for example, their corresponding transmitter, receiver, and/or transceiver). In some implementations, the modules 304, 306, and/or 308 are connected via the HVIL in a daisy chained manner. Such a configuration may allow the individual modules 304, 306, and/or 308 to determine their positions in the chain and use that determined information to identify and/or set unique identifiers accordingly. In some implementations, the timing of the pulse received at each module 304, 306, and/or 308 may be used to determine the module's position in the chain. In some implementations, the HVIL may be used to communicate the module's network identifier by modulating the pulse signal.

Accordingly, the single wire or communications link between each of the modules 304-308 (for example, the HVIL) performs multiple functions: 1) providing the pulse interrupt for the distributed safety circuit, and 2) providing for automatic network identifier assignment for each of the coupled modules. By doubling the functionality of the HVIL, the associated components may be more cost effective on a per function basis as compared to an implementation in which the components only perform one of the described functions.

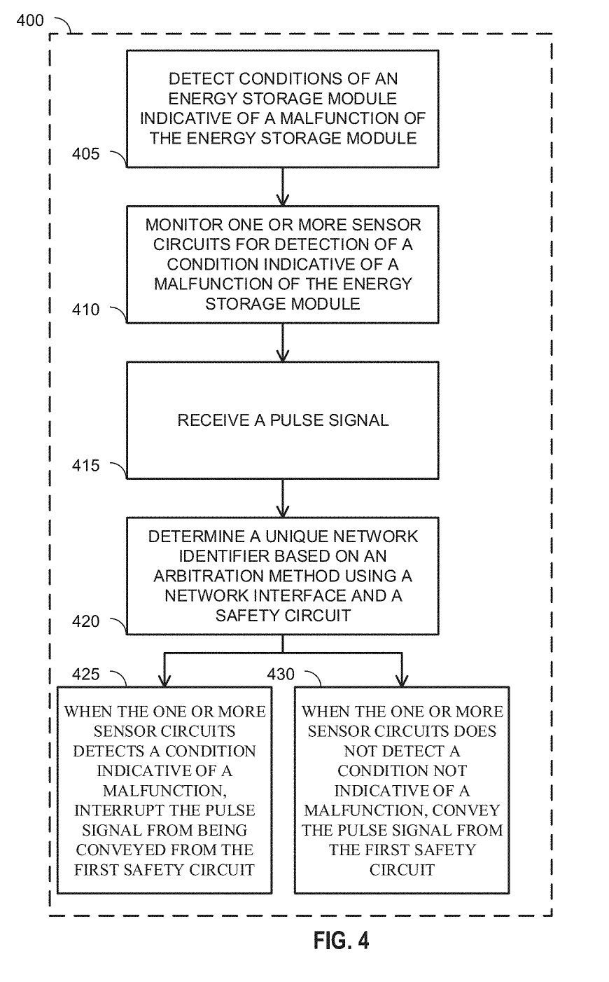

FIG. 4 illustrates a method of including an interlock loop for use with a method 400 for automatically configuring communication identifiers in the energy storage modules 104 of FIG. 1A. In some embodiments, one or more of the actions or processes described in the blocks of the method 400 may be performed by one or more components of the energy storage module 104. For example, one or more of the actions or processes may be performed by the processor 202, transceiver 214, pulse generator 220, sensors 224, and/or the safety circuit 228 of FIG. 2. A person having ordinary skill in the art will appreciate that the method 400 may be implemented by other suitable devices and systems. Although the method 400 is described herein with reference to a particular order, in various aspects, blocks herein may be performed in a different order, or omitted, and additional blocks may be added.

The method 400 begins at block 405, which includes detecting via one or more sensor circuits. The one or more sensor circuits may detect conditions of the energy storage module indicative of a malfunction of the energy storage module. In some embodiments, the one or more sensor circuits may generate a flag or return a value indicating whether or not any malfunction condition exists. For example, the generated flag may be a “1” if any malfunction condition exists or a value of “1” may be returned when a malfunction condition exists. In some embodiments, the one or more sensor circuits may return a value that the processor 202 or processing system determines to indicate a malfunction condition exists.

In some embodiments, the method 400 may further include monitoring the one or more sensor circuits for detection of the condition indicative of a malfunction of the energy storage module, as shown in optional block 410. In some embodiments, the optional monitoring may be performed by the safety circuit 228 or the processor 202. At block 415, the method 400 includes receiving a pulse signal. In some embodiments, the pulse signal may be received by the transceiver 214 or the safety circuit 228. At block 420, the method 400 includes determining a unique network identifier based on an arbitration method using said network interface in conjunction with the safety circuit 228. In some embodiments, this may be performed by one or more of the processor 202, the transceiver 214, the memory 206, and/or the user interface 222. At block 425, when the malfunction condition is detected, the method 400 may include interrupting the pulse signal from being conveyed from the first safety circuit. In some embodiments, this may be performed by the safety circuit 228 or the processor 202 or an internal switch, etc. (not shown). Alternatively, or additionally, at block 430, when the malfunction condition is not detected, the method 400 may include conveying the pulse signal from the first safety circuit. In some embodiments, this may be performed by one or more of the processor 202 and/or the safety circuit 228.

In some implementations, the method 400 may be performed by an energy storage module. The energy storage module may comprise one or more energy storage cells, one or more sensor circuits, a network interface, and a safety circuit. The one or more sensor circuits may detect conditions of the energy storage module that are indicative of a malfunction of the energy storage module. The safety circuit may monitor the one or more sensor circuits for detection of a condition indicative of a malfunction of the energy storage module. The safety circuit may also receive a pulsed signal. When the one or more sensor circuits detects a condition indicative of a malfunction of the energy storage module, the safety circuit may interrupt the pulsed signal from being conveyed from the safety circuit. When the one or more sensor circuits does not detect a condition indicative of a malfunction of the energy storage module, the safety circuit may convey the pulsed signal from the first safety circuit. Additionally, a unique network identifier of the network interface may be determined based on an arbitration method using said network interface in conjunction with the safety circuit.

In some implementations, the method 400 may be performed by an energy storage module. The energy storage module may perform one or more of the functions of method 400, in accordance with certain implementations described herein. The apparatus may comprise means for detecting a condition indicative of a malfunction of the energy storage module. In certain implementations, the means for detecting a condition can be implemented by the one or more sensors 224 (FIG. 2). In some implementations, the means for detecting a condition can be configured to perform the functions of block 405 (FIG. 4). The apparatus may further comprise means for receiving and conveying a pulsed signal. In certain implementations, the means for receiving and conveying can be implemented by the safety circuit 228. In certain implementations, the means for receiving and conveying can be configured to perform the functions of block 415 (FIG. 4). The apparatus may further comprise means for determining an unique network identifier of a network interface based an arbitration method using said network interface in conjunction with the means for receiving and conveying. In certain implementations, the means for determining the unique network identifier can be implemented by the processor 204 or the transmitter 210, the receiver 212, the transceiver 214, or the user interface 222. In certain implementations, the means for determining the unique network identifier can be configured to perform the functions of block 420 (FIG. 4). The apparatus may further comprise means for interrupting the pulsed signal being conveyed from the means for receiving and conveying when the condition indicative of a malfunction of the energy storage module is detected. In certain implementations, the means for interrupting can be implemented by the processor 204 or the safety circuit 228. In certain implementations, the means for interrupting can be configured to perform the functions of block 425 (FIG. 4). The apparatus may further comprise means for interrupting the pulsed signal being conveyed from the means for receiving and conveying when the condition indicative of a malfunction of the energy storage module is detected. In certain implementations, the means for interrupting and conveying can be implemented by the processor 204 or the safety circuit 228. In certain implementations, the means for interrupting and conveying can be configured to perform the functions of block 425 (FIG. 4).

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and method steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the implementations.

The various illustrative blocks, modules, and circuits described in connection with the implementations disclosed herein may be implemented or performed with a general purpose hardware processor, a Digital Signal Processor (DSP), an Application Specified Integrated Circuit (ASIC), a Field Programmable Gate Array (FPGA) or other programmable logic device, discrete gate or transistor logic, discrete hardware components, or any combination thereof designed to perform the functions described herein. A general purpose hardware processor may be a microprocessor, but in the alternative, the hardware processor may be any conventional processor, controller, microcontroller, or state machine. A hardware processor may also be implemented as a combination of computing devices, for example, a combination of a DSP and a microprocessor, a plurality of microprocessors, one or more microprocessors in conjunction with a DSP core, or any other such configuration.

The steps of a method and functions described in connection with the implementations disclosed herein may be embodied directly in hardware, in a software module executed by a hardware processor, or in a combination of the two. If implemented in software, the functions may be stored on or transmitted as one or more instructions or code on a tangible, non-transitory computer readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the hardware processor such that the hardware processor can read information from, and write information to, the storage medium. In the alternative, the storage medium may be integral to the hardware processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer readable media. The hardware processor and the storage medium may reside in an ASIC.

For purposes of summarizing the disclosure, certain aspects, advantages and novel features have been described herein. It is to be understood that not necessarily all such advantages may be achieved in accordance with any particular implementation. Thus, the present disclosure may be embodied or carried out in a manner that achieves or optimizes one advantage or group of advantages as taught herein without necessarily achieving other advantages as may be taught or suggested herein.

Various modifications of the above-described implementations will be readily apparent, and the generic principles defined herein may be applied to other implementations without departing from the spirit or scope of the application. Thus, the present application is not intended to be limited to the implementations shown herein but is to be accorded the widest scope consistent with the principles and novel features disclosed herein.

What is claimed is:

1. An energy storage module comprising:
one or more energy storage cells;
one or more sensor circuits configured to detect a condition of the energy storage module indicative of a malfunction of the energy storage module;
a network interface; and
a first safety circuit configured to:
monitor the one or more sensor circuits for detection of the condition indicative of a malfunction of the energy storage module,
receive a pulsed signal, and
when the one or more sensor circuits detect the condition indicative of a malfunction of the energy storage module, interrupt the pulsed signal being conveyed from the first safety circuit, and
when the one or more sensor circuits does not detect the condition indicative of a malfunction of the energy storage module, convey the pulsed signal from the first safety circuit,
wherein a unique network identifier of the network interface is determined based on an arbitration method using said network interface in conjunction with the first safety circuit.

2. The energy storage module of claim 1, wherein the first safety circuit is electrically coupled to a second safety circuit of an upstream or a downstream energy storage module.

3. The energy storage module of claim 2, wherein the first and second safety circuits are coupled via a wired connection.

4. The energy storage module of claim 1, further comprising a pulse generator configured to generate the pulse signal for conveyance through the first safety circuit, wherein the first safety circuit comprises an input coupled to the pulse generator and an output coupled to a second safety circuit of a downstream energy storage module.

5. The energy storage module of claim 1, wherein the first safety circuit comprises an input coupled to a second safety circuit of an upstream energy storage module and an output coupled to a third safety circuit of a downstream energy storage module.

6. The energy storage module of claim 1, wherein in order to interrupt the pulsed signal, the first safety circuit is configured to one or more of: truncate the pulse signal or adjust one of a pulse width, an amplitude, a frequency, or a periodicity of the pulse signal.

7. The energy storage module of claim 6, wherein the truncated or adjusted pulse signal indicates the malfunction of the energy storage module.

8. The energy storage module of claim 1, wherein the arbitration method uses a communication through the first safety circuit to identify that the network interface is to be assigned the unique identifier.

9. A method of monitoring an energy storage module, the method comprising:
detecting a condition of an energy storage module indicative of a malfunction of the energy storage module;
receiving a pulsed signal;
determining an unique network identifier of a network interface based an arbitration method using said network interface in conjunction with a safety circuit;
when the condition indicative of a malfunction of the energy storage module is detected, interrupting the pulsed signal being conveyed from a first safety circuit; and
when the condition indicative of a malfunction of the energy storage module is not detected, conveying the pulsed signal from the first safety circuit.

10. The method of claim 9, wherein the first safety circuit is electrically coupled to a second safety circuit of an upstream or a downstream energy storage module.

11. The method of claim 10, wherein the first and second safety circuits are coupled via a wired connection.

12. The method of claim 9, further comprising generating, via a pulse generator, the pulse signal for conveyance through the first safety circuit, wherein the first safety circuit comprises an input coupled to the pulse generator and an output coupled to a second safety circuit of a downstream energy storage module.

13. The method of claim 9, wherein the first safety circuit comprises an input coupled to a second safety circuit of an upstream energy storage module and an output coupled to a third safety circuit of a downstream energy storage module.

14. The method of claim 9, wherein interrupting the pulsed signal comprises one or more of: truncating the pulse signal or adjusting one of a pulse width, an amplitude, a frequency, or a periodicity of the pulse signal.

15. The method of claim 14, wherein the truncated or adjusted pulse signal indicates the malfunction of the energy storage module.

16. The method of claim 9, wherein the arbitration method uses a communication through the first safety circuit to identify that the network interface is to be assigned the unique identifier.

17. An energy storage module, comprising:
means for detecting a condition indicative of a malfunction of the energy storage module;
means for monitoring the means for detecting for detection of the condition indicative of a malfunction of the energy storage module;
means for receiving and conveying a pulsed signal;
means for determining an unique network identifier of a network interface based an arbitration method using said network interface in conjunction with the means for receiving and conveying; and
means for interrupting the pulsed signal being conveyed from the means for receiving and conveying when the condition indicative of a malfunction of the energy storage module is detected,
wherein the means for receiving and conveying a pulsed signal conveys the pulsed signal when the condition indicative of a malfunction of the energy storage module is not detected.

18. The module of claim 17, further comprising means for generating the pulse signal for conveyance through the first safety circuit, wherein the first safety circuit comprises an input coupled to the means for generating the pulse signal and an output coupled to a second safety circuit of a downstream energy storage module.

19. The module of claim 17, wherein the means for interrupting the pulsed signal is configured to one or more of: truncate the pulse signal or adjust one of a pulse width, an amplitude, a frequency, or a periodicity of the pulse signal.

20. The module of claim 17, wherein the arbitration method uses a communication through the first safety circuit to identify that the network interface is to be assigned the unique identifier.
